(19) United States
(12) Patent Application Publication
(10) Pub. No.: US 2002/0128003 A1
(43) Pub. Date: Sep. 12, 2002

(54) Telecommunication gateway between a private network and mobile network

(76) Inventors: Richard Gruner, Selestat (FR); Daniel Bertrand, Eschau (FR); Antoine Lingat, Obernai (FR); Eric Vallet, Versailles (FR); Martin De Loye, Sevres (FR); Jean-Francois Deprun, Paris (FR)

Correspondence Address: Sughrue Mion Zinn Macpeak & Seas, 2100 Pennsylvania NW Suite 800, Washington, DC, 20037-3213, US

(21) Appl. No.: 09/889,979

(22) PCT Filed: Dec. 6, 2000
(86) PCT No.: PCT/FR00/03404

(30) Foreign Application Priority Data
Dec. 6, 1999 (FR) 99 15 361

(51) Int. Cl. H04Q 7/20

(52) U.S. Cl. 455/422

(57) ABSTRACT

An object of the invention is to provide services available on a private network (14) to a user of a mobile terminal (12) connected to a public or private mobile network (10). To this end, the invention provides a telecommunications gateway (22) which is connected between the exchange of the private network (14) and the mobile network. The gateway converts signaling data from the exchange (16) of the private network (14) to a format compatible with a protocol enabling transmission of information and services to and from a mobile terminal, for example the wireless application protocol. It then sends the converted signaling data to the mobile terminal (12) via the mobile network. In the reverse direction, the gateway converts signaling data from the mobile terminal to a format compatible with the exchange and transmits the converted signaling data to the exchange. The invention enables use of services of the private network—call forwarding management, calling by name, etc.—from a mobile terminal.

The present invention relates to mobile terminals of telecommunications networks and more specifically to private network services available on mobile terminals.

Mobile telecommunications networks are known in the art. GSM and DECT networks are examples of mobile telecommunications networks.

There are various types of private network. Private networks provide specific services, for example a call-by-name service, a call forwarding management service, a message service, a camp on busy subscriber service, etc.

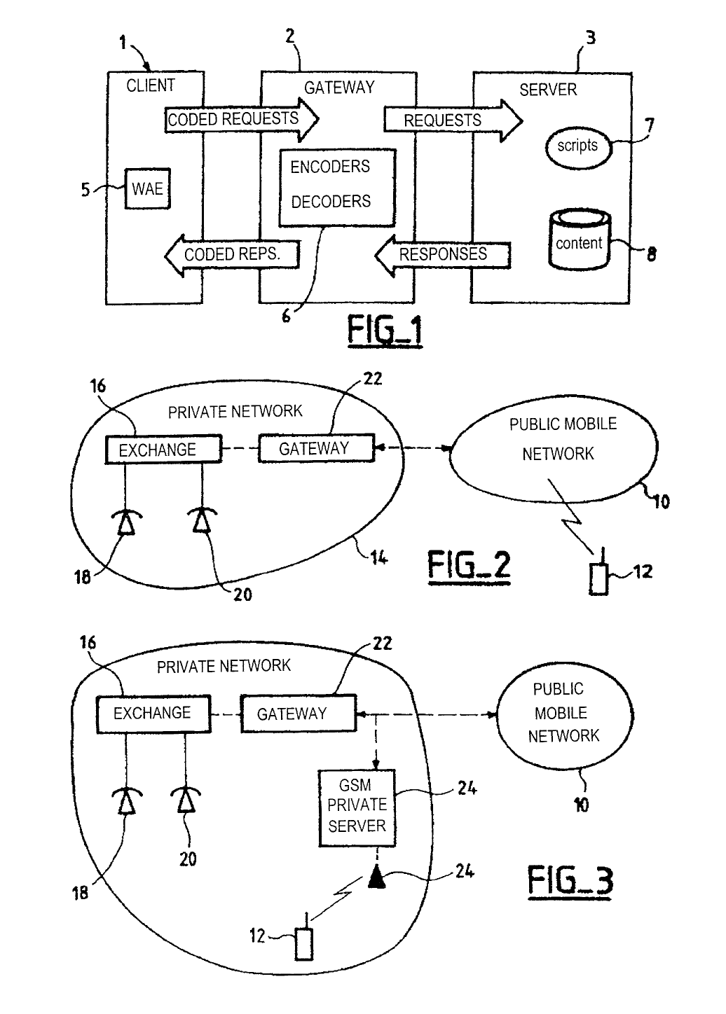

The various entities constituting the wireless telecommunications industry have set up an organization known as the wireless application protocol forum (www.wapforum.org). The purpose of this organization is to develop the wireless application protocol (WAP), which enables data services, and in particular Internet services, to be offered on mobile terminals, and in particular on digital terminals of wireless telecommunications networks. FIG. 1, which is taken from the WAP white paper entitled “Wireless Internet Today”, June 1999, shows the WAP programming model, which is a key element of the WAP specification. As shown in the figure, the WAP programming model manages exchanges of data between a client 1 and a conventional server 3 via a gateway 2. The client's application layer includes a wireless application environment (WAE) 5. The gateway 2 includes encoders and decoders 6 for communicating with the client, in a language defined in the specification, and with the server. The server conventionally features scripts 7 or the like, together with content 8.

The client 1 transmits requests encoded to the WAP format to the gateway 2, where they are decoded and transmitted to the server 3. In the opposite direction, the server transmits the response—i.e. the content supplied by the server—to the gateway 2, where it is encoded in the WAP format; the response is then transmitted to the client 1.

WAP servers are already available off the shelf. For example, in June 1999 Nokia published a product data sheet concerning the Nokia WAP Server, which is a gateway between mobile terminals which use the wireless application protocol and Web servers accessed via the Internet or an Intranet. It provides mobile terminals with access to data provided by the servers.

In France, the public mobile telephone operator SFR offers users information services, marketed under the name “e-media”, using a wireless application protocol to transmit information to user terminals.

A new problem for users of services provided by private networks is to be able to continue to use those services even when they are not connected to the private network and are using a mobile terminal.

The invention proposes a solution to this new problem. It enables a mobile terminal user to obtain on their terminal services usually offered by a private network; for example, the user can use call forwarding management and calling by name services, or use other services.

To be more precise, the invention proposes a telecommunications gateway, including:

means for connecting to an exchange of a private network;

means for connecting to a mobile network;

means for converting signaling data from said means for connecting to an exchange to a format compatible with a protocol enabling transmission of information and services from and to a mobile terminal and for transmitting the converted signaling data to the means for connecting to a mobile network; and

means for converting signaling data in said format from said means for connecting to a mobile network to a format compatible with an exchange and for transmitting the converted signaling data to the means for connecting to an exchange.

In one embodiment, the protocol enabling transmission of information and services to and from a mobile terminal is the wireless application protocol.

The invention also provides a telecommunications system including:

a gateway of the above kind;

a private network with an exchange connected to the means for connecting said gateway to an exchange; and

a mobile network connected to the means for connecting said gateway to a mobile network.

In one embodiment, the mobile network is a public mobile network. In another embodiment, the mobile network is a private mobile network.

The invention finally provides a method of providing the services of an exchange of a private network to a user of a mobile terminal connected to a mobile network, the method including the steps of:

converting signaling data from the exchange to a format compatible with a protocol enabling transmission of information and services to and from a mobile terminal;

transmitting the converted signaling data to the mobile terminal via the mobile network;

converting signaling data in said format received from the mobile terminal via the mobile network to a format compatible with an exchange; and

transmitting the converted signaling data to the exchange.

Said protocol is preferably a wireless application protocol.

The gateway and the method according to the invention provide a new service which is characterized in that, to set up a voice call from a mobile terminal connected to a public mobile telephone network to another terminal, it includes the steps of:

setting up a data transmission call between the mobile terminal and a gateway via a public mobile telephone network; and

executing a script in said gateway to command an exchange to call back said mobile terminal and call said other terminal and then set up a voice call between said two terminals.

Other advantages and features of the invention will become apparent on reading the following description of embodiments of the invention, which description is given by way of example only and with reference to the accompanying drawings, in which:

FIG. 1 is a block diagram of a WAP programming model;

FIG. 2 is a block diagram of a first embodiment of the invention;

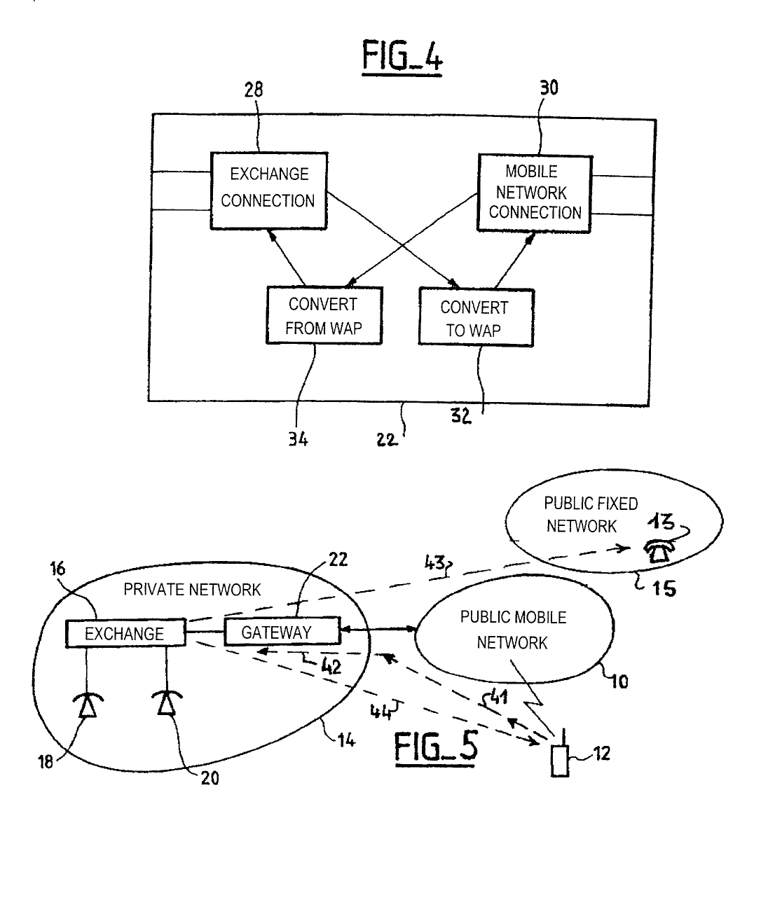

FIG. 3 is a block diagram of a second embodiment of the invention;

FIG. 4 is a block diagram of a gateway according to the invention; and

FIG. 5 shows an application of the gateway according to the invention.

The invention enables a mobile terminal user to access services usually provided by a private network to fixed stations connected to the network. The invention proposes to provide the services to the user via the public or private network to which the mobile terminal is connected. To this end, the invention proposes to use the wireless application protocol—or another protocol having the same effect—to transmit the services to the user. The private network providing the services is connected via a gateway to the public or private network to which the mobile terminal is connected.

In the remainder of the description, the invention is described with reference to the wireless application protocol. It is not limited to the wireless application protocol, however, but applies more generally, to any protocol enabling transmission of information and services to and from a mobile terminal.

FIG. 2 is a block diagram of a first embodiment of the invention. This embodiment of the invention is described in the context of a mobile terminal connected to a public network. The figure shows diagrammatically the public network 10, the mobile terminal 12 and a private network 14. The private network includes a private exchange 16 to which fixed terminals 18, 20 are connected. The exchange enables users of the fixed terminals 18, 20 to access services such as a calling by name service, a call forwarding management service and a message service, for example; the private network can also provide a charge metering service, in addition to call routing functions that are known in the art.

The object of the invention is to enable the user of the mobile terminal 12 to access the services of the private network. To this end, the invention proposes to use a gateway 22 between the exchange and the public mobile network to transmit signaling data to the mobile terminal and to receive signaling data from the mobile terminal; the gateway uses the wireless application protocol for transmission to the mobile terminal; the invention can therefore be implemented easily, without modifying the terminals and without any repercussions for the public network.

This is how the invention works. In the direction from the exchange to the mobile terminal, signaling data supplied by the private exchange is supplied to the gateway; the gateway converts the data into wireless application protocol data that can be transmitted to the mobile terminal via the public network. The converted data is transmitted to the mobile network 10 and to the user.

The user's terminal receives the signaling data supplied by the exchange via the gateway; the user can respond by sending other signaling data, also in the WAP format. The data is transmitted via the public network 10 to the gateway 22, which converts the signaling data received from the mobile terminal into data in a format compatible with the exchange and transmits the data to the exchange.

This two-way exchange of signaling data enables the mobile terminal user to access services of the private network exchange without being physically connected to the private network. It is clear that using services of the exchange can entail more than two exchanges of signaling data.

Various examples of services that can be provided to a mobile terminal user are given next. The services can be services relating directly to the user's mobile terminal or services relating to a fixed terminal of the private network assigned to the mobile terminal user; in the latter case, the fixed terminal can be a real fixed terminal—the fixed terminal in the mobile terminal user's office—or a virtual fixed terminal—a terminal number allocated by the private network exchange to the user, without there being any corresponding real physical terminal. Note that, the mobile terminal user is identified for the purposes of setting up a WAP connection with the exchange via the gateway, so that the exchange can determine which fixed terminal of the private network belongs to the mobile terminal user.

A first example concerns programming characteristics of the private network terminal. From his mobile terminal, the user can program functions of the fixed terminal, for example he can activate or deactivate call forwarding; he can authorize call forwarding to other terminals of the private network or to terminals outside the private network. Other programming functions of the private network fixed terminal usually accessible on the fixed terminal can also be offered to the user of the mobile terminal: call number programming, etc.

A second example concerns the calling by name function from the mobile terminal. In this case, the exchange transmits to the mobile terminal the names of the various users of the private network; the mobile terminal user can then select a name and make the corresponding call. Of course, the mobile terminal is not connected directly to the private network, but in reality to the public network. Calling by name is made possible in the manner described in patent application EP-A-0 944 270: as explained in that patent application, to use the calling by name service, the mobile terminal user selects the name of a called party; in reality the terminal dials an access number of the exchange and transmits to the exchange the information necessary for routing the call via the private network to the called party.

Other examples of functions are consulting callback requests or unanswered calls, consulting text or voice messages, redirecting faxes (to request printout on the nearest fax machine after consulting the coordinates of the sender on the GSM screen), etc.

FIG. 3 is a block diagram of a second embodiment of the invention. In the FIG. 3 embodiment, the mobile terminal is not connected to the public mobile network, but instead to a private wireless network. The figure therefore shows a GSM private server 24 with a private base station 26. The mobile terminal 28 is connected to the base station 26. The GSM private server is connected to the gateway, as the public network was in the FIG. 2 embodiment.

This embodiment of the invention works in exactly the same way as the FIG. 2 embodiment, substituting “private mobile network” for “public mobile network”. As in the FIG. 2 embodiment, the FIG. 3 embodiment can simply use the WAP functions of the GSM private server or the terminals without modifying them.

FIG. 4 is a block diagram of a gateway according to the invention. The gateway 22 includes means 28 for connecting to an exchange of a private network (14), in a conventional format, for example in accordance with the Internet protocol (IP). It includes means 30 for connecting it to a mobile network and means 32 for converting signaling data from an exchange to a format compatible with a wireless application protocol. Finally, it includes means 34 for converting signaling data from a mobile network user in the format compatible with a wireless application protocol to a format compatible with an exchange.

A large organization generally operates on several sites which have telephone exchanges connected in a network. The exchanges use cost optimization methods to choose the best path when a call must be set up between two remote sites. For example, it is cheaper to have a call routed through a public network line already leased by the organization, rather than use an ad hoc public network line.

In addition to the conventional services provided by private exchanges, the gateway described above can provide a new service that enables an employee of an organization to benefit from these cost optimization methods when he is not on the premises of the organization and is using a GSM terminal connected to a public mobile telephone network.

Instead of dialing the number of the called station, the employee dials a number calling the gateway to set up a data transmission call in accordance with the wireless application protocol. The exchange sends the terminal a page enabling it to choose between various services, and in particular a personal directory. The user chooses the number he wishes to call and then terminates the call. The exchange then performs two callbacks: one to the called station and the other to the user.

FIG. 5 illustrates the new service. The gateway 22 includes software for executing a script sending an instruction to the exchange 16 to initialize two callbacks, one to the called station and the other to the user.

That software is activated by a call from a mobile terminal, such as the terminal 12, which requests the setting up of a call with another terminal that is not part of the private network 14, for example the fixed terminal 13 of the public fixed network 15. The process for calling a station of the private network 14 is the same.

The sequence of operations is as follows:

41: the terminal 12 sets up a data transmission call to the gateway 22 of the private network 14 via the public mobile network 10. The gateway 22 sends a page in WML and conforming to the wireless application protocol to the terminal 12. The page is displayed by the terminal 12 and enables the user to choose between services available on the exchange 16, in particular a personal directory. The user chooses to access the directory, for example, and from the directory chooses the number of the terminal 13 to be called. Each command is transmitted to the gateway 22 in WML and in accordance with the wireless application protocol.

42: the gateway 22 executes a script sending an instruction to the exchange 16.

43: that instruction initializes a callback 43 to the terminal 13.

44: the instruction also initializes a callback 44 to the terminal 12.

The exchange 16 then sets up the voice connection between the terminals 12 and 13. The cost of voice communications between the two terminals is charged to the private network 14. The cost of the call is generally lower than if the user had called the station 13 directly via the public network.

Any GSM mobile telephone able to send and receive data in accordance with the wireless application protocol and then voice signals can use the gateway according to the invention and the new service.

Of course, the invention is not limited to the embodiments described and shown; in particular, the user of the mobile terminal can be provided with access to services of the exchange other than those cited above by way of example. In the FIG. 3 embodiment, the private network 14 includes a private exchange and a GSM private server; however, other examples could be given in which these entities would be parts of two separate private networks.

Although the invention has been described in the context of the GSM, it also applies to other mobile telecommunications standards.

1. A telecommunications gateway (22) including:
means (28) for connecting to an exchange of a private network (14);
means (30) for connecting to a mobile network (10; 24, 26);
means (32) for converting signaling data from said means for connecting to an exchange to a format compatible with a protocol enabling transmission of information and services from and to a mobile terminal and for transmitting the converted signaling data to the means (30) for connecting to a mobile network; and
means (34) for converting signaling data in said format from said means (30) for connecting to a mobile network to a format compatible with an exchange and for transmitting the converted signaling data to the means (28) for connecting to an exchange.

2. A gateway according to claim 1, characterized in that the protocol enabling transmission of information and services to and from a mobile terminal is the wireless application protocol.

3. A gateway according to either preceding claim, characterized in that it includes means for executing a script for sending an instruction to the exchange (16) to initialize a callback to two separate numbers and then to set up a voice call between the terminals (12, 13) corresponding to those two numbers.

4. A telecommunications system including:
a gateway according to any preceding claim;
a private network (10) with an exchange (16) connected to the means (28) for connecting said gateway to an exchange; and
a mobile network (10; 24, 26) connected to the means (30) for connecting said gateway to a mobile network.

5. The system according to claim 4, characterized in that the mobile network is a public mobile network (10).

6. The system according to claim 4, characterized in that the mobile network is a private mobile network (24, 26).

7. A method of providing the services of an exchange (16) of a private network (14) to a user of a mobile terminal (12) connected to a mobile network (10; 24, 26), the method including the steps of:
converting signaling data from the exchange to a format compatible with a protocol enabling transmission of information and services to and from a mobile terminal;
transmitting the converted signaling data to the mobile terminal (12) via the mobile network (10; 24, 26);
converting signaling data in said format received from the mobile terminal (12) via the mobile network to a format compatible with an exchange; and
transmitting the converted signaling data to the exchange (16).

8. The method according to claim 7, characterized in that said protocol is a wireless application protocol.

9. The method according to either claim 7 or claim 8, characterized in that, to set up a voice call from a mobile terminal (12) connected to a public mobile telephone network to another terminal (13), it includes the steps of:
setting up a data transmission call (41) between the mobile terminal (12) and a gateway (22) via a public mobile telephone network (10); and
executing a script in said gateway (22) to command an exchange (16) to call back said mobile terminal (12) and call said other terminal (13) and then to set up a voice call between said two terminals.

10. The method according to claim 9, characterized in that it further consists of sending from the exchange (16) to the mobile terminal (12) a page constituting a telephone directory for choosing the number of the other terminal to be called during the data transmission call.
